(19) United States
(12) Patent Application Publication
(10) Pub. No.: US 2015/0271125 A1
(43) Pub. Date: Sep. 24, 2015

(54) INFORMATION RETRIEVAL SYSTEM

(71) Applicant: Gustaf RYDING, Mariefred (SE)

(72) Inventor: Gustaf RYDING, Mariefred (SE)

(21) Appl. No.: 14/537,371

(22) Filed: Nov. 10, 2014

Related U.S. Application Data
(63) Continuation of application No. 13/392,666, filed on Apr. 24, 2012, now abandoned.

(30) Foreign Application Priority Data
Aug. 28, 2009 (SE) 0901138-8

(51) Int. Cl. H04L 12/58

(52) U.S. Cl. CPC H04L 51/30; H04L 51/34

(57) ABSTRACT

An information retrieval system wherein a telecom network is used for transmitting to a terminal from a computer packets of information represented visually as pages, the packets of information being stored in the form of information blocks each having a first information packet representing a message of a corresponding page and a second information packet representing data relating to the same page. The message and data relate to electronic receipts and warranty registrations, respectively, and the information blocks include a third information packet arranged in combination with the first information packet to be received from a transaction equipment via the telecom network and to instruct the computer to make the transmittals in such a way that the data relating to the warranty registrations are represented visually at the terminal as information added to the message relating to the electronic receipts and located inside a chosen subfield of the page.

### FIELD OF INVENTION

The invention relates to an information retrieval system in which a telecom network is used for transmitting to a terminal from a computer packets of information represented visually as pages, said packets of information being stored by the computer in the form of information blocks each comprising a first information packet representing a message of a corresponding page and a second information packet representing data relating to the same page.

### BACKGROUND OF THE INVENTION

An information retrieval system for the millions was, as defined above and described in U.S. Pat. No. 4,873,662, pioneered more than 30 years ago by the UK Post Office. Domestic television receivers were proposed to present pages received via the public telephone network from a computer that stored hidden data relating to the presented pages. Home computers replaced quickly television receivers as terminals and access to large information centers can today be provided also via mobile phones.

While mobile phones offer a limited space on the screen, their omnipresence make them desirable for all kinds of different applications as information retrieval terminals. Since electronic receipt and warranty support systems are of interest to everybody and not particularly difficult for the man skilled in the art to develop with home computers and mobile phones used as terminals, the potential market seems to have been held back by lack of proposals providing a sufficiently convenient solution.

### SUMMARY OF THE INVENTION

A main object of the invention is to propose an information retrieval system that can make it convenient for the millions to use such electronic receipt and warranty support systems as described in the U.S. Pat. No. 6,341,353 and US 2003/0061104. According to the invention, said message and said data of the above defined information retrieval system relate to electronic receipts and warranties, respectively. Said information blocks comprise a third information packet arranged in combination with said first information packet to be received from a transaction equipment via said telecom network and to instruct said computer to make said transmittals in such a way that said data relating to said warranty registrations are represented visually at said terminal as information added to said message relating to said electronic receipts and located inside a chosen subfield of said page. Other characteristics of the invention will appear from the description and the claims.

The information retrieval system of the invention will now be described more in detail with reference to the accompanying drawing that shows a preferred embodiment.

### BRIEF DESCRIPTION OF THE DRAWINGS

FIG. 1 shows an overview of an information retrieval system according to the invention.

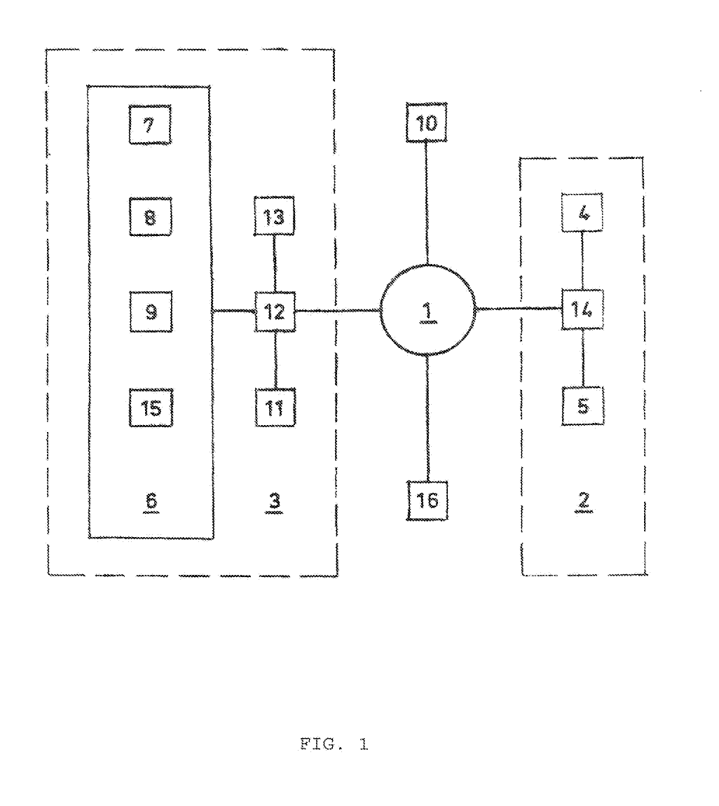

### PREFERRED EMBODIMENT

In the drawing, an information retrieval system is shown in which a telecom network 1 is used for transmitting to a terminal 2 from a computer 3 packets of information represented visually as pages on a screen 4. The terminal 2 is provided with control means 5 for transmitting responses via the telecom network 1 and for selecting a page. Said packets of information are stored by the computer 3 in a memory 6 and in the form of information blocks each comprising a first information packet 7 representing a message of a corresponding page and a second information packet 8 representing data relating to the same page.

According to the invention, said message and said data of the above defined information retrieval system relate to electronic receipts and warranty registrations, respectively. Said information blocks comprise a third information packet 9 arranged in combination with said first information packet to be received from a transaction equipment 10 via the telecom network 1 and to instruct said computer 3 to make said transmittals in such a way that said data relating to said warranty registrations are represented visually at the terminal 2 as information added to said message relating to said electronic receipts and located inside a chosen subfield of said page, for example near the bottom. The computer 3 comprises suitable control means 11, a processor 12 and a screen 13. A processor 14 is also included in the terminal 2.

In the preferred embodiment of the invention, said information blocks comprise a fourth information packet 15 received from the transaction equipment 10 via the telecom network 1 and providing optional contact data from purchasers to which said electronic receipt messages and warranty registration data are to be presented. The computer 3 is arranged to convert these optional contact data into client codes that represent the purchasers without traceable identities, and that are combined with said warranty registration data inside said subfield of the page transmitted to the terminal 2. The client codes and the computer 3 can by means of the telecom network 1 and any suitable terminal 16 help purchasers to keep track of their warranties and manufacturers of purchased products to update warranty information and to extract statistical data.

For the convenience of the purchasers, it is possible to use as said terminal 2 both their mobile phones and a fixed terminal provided with a large screen and located at the transaction equipment 10. As optional contact data, they can provide a GSM mobile phone number to receive said receipt messages and warranty data via SMS in a limited presentation format or provide an E-mail address to receive a full page presentation.

1. An information retrieval system in which a telecom network (1) is used for transmitting to a terminal (2) from a computer (3) packets of information represented visually as pages, said packets of information being stored by the computer in the form of information blocks each comprising a first information packet (7) representing a message of a corresponding page and a second information packet (8) representing data relating to the same page, characterized thereby that said message and said data relate to electronic receipts and warranty registrations, respectively, and that said information blocks comprise a third information packet (9) arranged in combination with said first information packet to be received from a transaction equipment (10) via said telecom network and to instruct said computer to make said transmittals in such a way that said data relating to said warranty registrations are represented visually at said terminal as information added to said message relating to said electronic receipts and located inside a chosen subfield of said page.

2. An information retrieval system according to claim 1, characterized thereby that said information blocks comprise a fourth information packet (15) received from said transaction equipment via the telecom network and providing optional contact data from purchasers to which said electronic receipts and warranty registration data are to be presented.

3. An information retrieval system according to claim 2, characterized thereby that said computer is arranged to convert said optional contact data into client codes that represent the purchasers without traceable identities and are combined with said warranty registration data inside said subfield of the page transmitted to the terminal.
